(19) United States
(12) Patent Application Publication
(10) Pub. No.: US 2006/0201334 A1
(43) Pub. Date: Sep. 14, 2006

(54) Toaster with warming function

(76) Inventor: John Belanger, Crown Point, IN (US)

Correspondence Address: JOHN ALEXANDER GALBREATH, 2516 CHESTNUT WOODS CT, REISTERSTOWN, MD, 21136, US

(21) Appl. No.: 11/266,816

(22) Filed: Nov. 4, 2005

Related U.S. Application Data
(60) Provisional application No. 60/661,574, filed on Mar. 14, 2005.

(51) Int. Cl. A47J 37/08

(52) U.S. Cl. 99/389

(57) ABSTRACT

A toaster is disclosed with a warming function that operates after the toasting cycle is complete, thereby keeping the toast warm in the toasting chamber until the user is ready to remove it. The warming function is accomplished via a warming cycle timing circuit which is interposed between the conventional toast cycle timing circuit and the electromagnet that holds the toast down within the toaster. Instead of the toast being released at the end of the toasting cycle as in a conventional toaster, the invention releases the toast when the desired warming time has expired. During the warming cycle, the toasting element operates at reduced power and produces less heat.

### CROSS-REFERENCES TO RELATED APPLICATIONS:

This application claims priority from, and the benefit of, applicant's provisional U.S. patent application Ser. No. 60/661,574, filed Mar. 14, 2005 and titled “Electronic Warming Feature To Add To A Toaster”. The disclosures of said application and its entire file wrapper (including all prior art references cited therewith) are hereby specifically incorporated herein by reference in their entirety as if set forth fully herein. Furthermore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The invention is in the area of toasters.

2. Description of the Related Art

Various prior art patents attempt to solve the problem of keeping items warm after they have been toasted. However, none of these patents exhibit the features of the present invention, nor do they match its functionality and versatility.

U.S. Pat. Nos. 2,862,441 to Schmall; 2,465,577 to Cox; 6,205,911 to Ochoa; 6,595,118 to Gould; 4,404,898 to Chaudoir; 6,305,273 to Sherman; 5,694,831 to Haroun; and 6,265,695 to Liebermann discuss the problem of keeping toast or other baked items warm after the toasting is finished. However, their approaches to solving the problem are all different than that of the invention. Schmall's device uses the same heating element to toast and warm, with flaps that direct heat alternatively into the toaster or the warming oven. But the toasting and warming chambers are separate, and the toast or other item must be moved from one chamber to the other. This is a distinct disadvantage in terms of ease of use.

Cox's device automatically moves the toast from the toasting area to separate warming chambers, and has separate heating elements for toasting and warming—unlike the invention which uses the toasting element to both toast and keep warm, in the same chamber. The devices of Ochoa, Gould, Chaudoir, and Sherman all have separate warming drawers, chambers, or racks that the toast is transferred to after toasting—unlike the invention which keeps the toast in place within the toaster.

Haroun's device is a combination toaster and cooking/warming oven, but the toasting and warming chambers are separate and use different heating elements. Finally, Liebermann's device is primarily a food heater/warmer with an additional browning oven. Liebermann's device could be used to toast items and then keep them warm—but as with several of the other prior art devices, the toasting and warming chambers are separate, and the toast or other item must be moved from one chamber to the other.

One other patent that discusses the problem of keeping of keeping toast warm after toasting is of general relevance—U.S. Pat. No. 6,523,458 to Turner. This device is only a warmer, however, and does not also have a toasting function.

In addition, U.S. Pat. No. 5,193,439 to Finesman discloses a toaster with programmable toasting cycles—but doesn't discuss programming the heating element to first toast at a high temperature and then keep warm at a lower temperature. Instead, the programmability is related to personal taste (the desired lightness or darkness of toast) or variety of baking products (toasting bread vs. pastries). U.S. Pat. No. 6,380,521 to Fanzutti discloses a coffeemaker with improved heating element control, but Fanzutti's heating element is not suitable for use in a toaster.

### SUMMARY OF THE INVENTION

The invention is a toaster with a warming function that operates after the toasting cycle is complete, thereby keeping the toast warm in the toasting chamber until the user is ready to remove it. The warming function is accomplished via a warming cycle timing circuit which is interposed between the conventional toast cycle timing circuit and the electromagnet that holds the toast down within the toaster. Instead of the toast being released at the end of the toasting cycle as in a conventional toaster, the invention releases the toast when the desired warming time has expired. During the warming cycle, the toasting element operates at reduced power and produces less heat.

Several objects and advantages of the invention are:

It is an object of the invention to provide a device and method that keeps toast or other items warm after they have been toasted, without having to move the items out of the toasting chamber into a warming chamber.

It is a further object of the invention to provide a device that uses the toasting element during the warming cycle.

It is a further object of the invention to provide a device in which the warming time can be adjusted from zero (no warming, just toasting) to a maximum time.

It is another object of the invention to provide a device in which the warming temperature can be adjusted from a relatively low temperature to a relatively high temperature.

It is yet another object of the invention to provide a device that can be effectively incorporated into conventional electronic magnetic hold-down toasters, as well as toaster ovens and other toasting devices that do not eject the toast or other item.

It is yet another object of the invention to provide a device that is relatively easy and cost-effective to manufacture.

Further objects and advantages of the invention will become apparent from a consideration of the ensuing description and drawings.

### DESCRIPTION OF THE DRAWINGS

FIG. 1 is a flow diagram that illustrates, in a general way, the main components and operating principles of the invention.

FIG. 2 is a schematic of the power supply that provides power to the various electronic components and circuits contained in the invention.

FIG. 3 further illustrates the full-wave bridge rectifier that is part of the power supply circuitry.

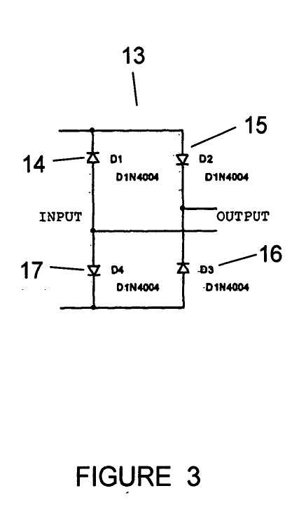

FIG. 4 is a schematic of the toast cycle timing circuit.

FIG. 5 is a schematic of the warming cycle timing circuit.

FIG. 6 is a schematic of the toasting and warming indicator lights.

FIG. 7 is a diagram of the toasting and heating elements and the relay switch which enables the transition from higher-power toasting to lower-power warming.

FIG. 8 is an alternative configuration of the toasting and heating elements, wherein a variable resistor has been inserted into the circuit so that the user can vary the warming temperature.

FIG. 9 illustrates the position of the toasting and heating elements in relation to the toast cycle timing circuit.

FIG. 10 is a perspective view of the toaster of the invention, showing the toasting chambers, warming time control knob, warming temperature control knob, toasting indicator light, and warming indicator light.

FIG. 11 is a side view of the toaster of the invention, showing the conventional lever that lowers the bread into the toaster and the conventional toasting time control knob.

### DETAILED DESCRIPTION OF THE INVENTION:

The following provides a list of the reference characters used in the drawings:

| | |
|---|---|
| 10. | A.C. power source |
| 11. | Power resistor |
| 12. | Power resistor |
| 13. | Full-wave bridge rectifier |
| 14. | Power diode |
| 15. | Power diode |
| 16. | Power diode |
| 17. | Power diode |
| 18. | Zener diode |
| 19. | Capacitor |
| 20. | Connection |
| 21. | Resistor |
| 22. | Resistor |
| 23. | Zener diode |
| 24. | Common terminal |
| 25. | Resistor |
| 26. | Resistor |
| 27. | Potentiometer |
| 28. | Resistor |
| 29. | Resistor |
| 30. | Capacitor |
| 31. | Resistor |
| 32. | Resistor |
| 33. | Resistor |
| 34. | Resistor |
| 35. | Capacitor |
| 36. | Transistor |
| 37. | Transistor |
| 38. | Relay |
| 39. | Resistor |
| 40. | Potentiometer |
| 41. | Diode |
| 42. | Capacitor |
| 43. | Resistor |
| 44. | Resistor |
| 45. | Capacitor |
| 46. | Transistor |
| 47. | Transistor |
| 48. | Transistor |
| 49. | Indicator |
| 50. | Indicator |
| 51. | Transistor |
| 52. | Transistor |
| 53. | Toasting element |
| 54. | Heating element |
| 55. | Variable resistor |
| 56. | Warming temperature control knob |
| 57. | Warming time control knob |
| 58. | Toasting time control knob |
| 59. | Electromagnet |
| 60. | Lowering lever |
| 61. | Toasting chambers |

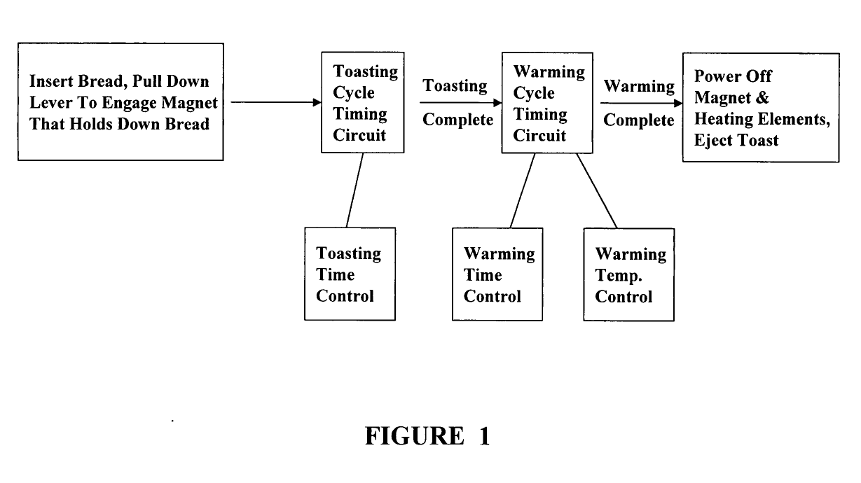

FIG. 1 provides a general overview of the main components and operating principles of the invention. First the user inserts the bread or other item to be toasted, and as in a conventional toaster, pulls down on the lever to start the toasting and engage the electromagnet that holds down the bread. The toast cycle timing circuit then controls the toasting time according to the setting of the toasting time control. In a conventional toaster, when the toasting was complete the toast cycle timing circuit would power off the heating elements and the electromagnet, thus stopping the toasting and releasing (popping-up) the toast.

In the invention, however, when the toasting is complete a warming cycle timing circuit is powered up. The length of the warming cycle is controlled by the warming time control switch, and the temperature of the warming cycle (i.e., the amount of power supplied to the heating elements during warming) is controlled by the warming temperature control switch. The heating elements stay on at a lower power for the duration of the warming cycle, and the toast is thereby kept warm in the toasting chamber. Only when the warming cycle is complete are the heating elements and the electromagnet powered off, thus stopping the warming and releasing (popping-up) the toast.

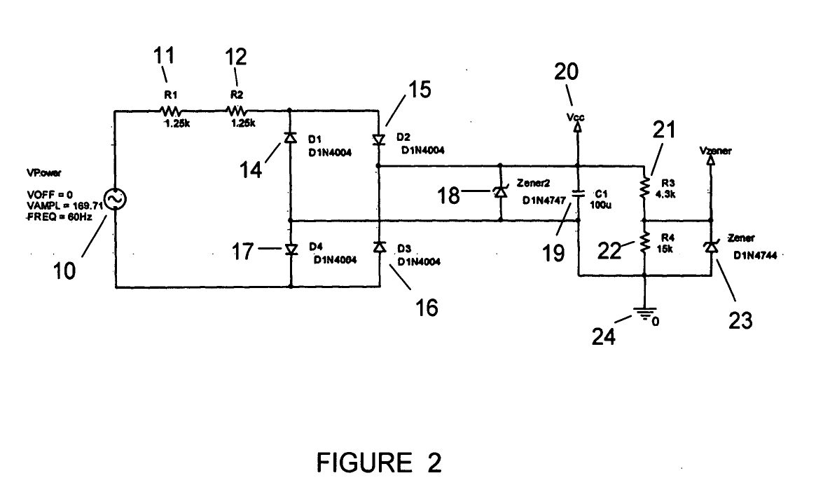

FIG. 2 is a schematic of the power supply that provides power to the various electronic components and circuits contained in the invention. As seen in FIG. 2, the power supply contains an alternating current (a.c.) power source 10, also labeled VPower on the schematic, which can be for example the wall outlet into which the toaster is plugged. The input power passes through power resistors 11 and 12, also labeled R1 and R2 on the schematic, which are connected in series with a full-wave bridge rectifier 13 which is comprised of power diodes 14, 15, 16, and 17, also labeled D1, D2, D3, and D4 on the schematic. Power resistors 11 and 12 are, suitably sized so as to provide the proper amount of power to the circuits and displays of the device. Power resistors 11 and 12 reduce the voltage from the power source so that bridge rectifier 13 only receives about 21 volts a.c. peak. Bridge rectifier 13 converts the a.c. voltage to d.c. (direct current) voltage.

Zener diode 18, also labeled Zener2 on the schematic, clamps the output voltage of bridge rectifier 13 at about 20 volts. Zener diode 18 also acts to stabilize the voltage Vcc as the timing circuits are switched on and off. Capacitor 19, also labeled C1 on the schematic, helps to smooth out the voltage ripples which result from the conversion of the a.c. voltage to d.c. voltage. The connection 20, also labeled Vcc on the schematic, provides the power which operates most of the electronics of the system. It should be understood that everywhere the Vcc symbol appears, this voltage is being applied, and that all of the Vcc symbols are connected to each other by wires which for convenience's sake do not explicitly appear on the schematics.

The d.c. voltage (Vcc) is applied through a resistor 21, also labeled R3 on the schematic, to the parallel combination of a resistor 22, also labeled R4 on the schematic, and a Zener diode 23, also labeled Zener on the schematic, to provide a voltage, Vzener, of about 13 volts which is used as the reference voltage for the timing circuits. It should be understood that everywhere the Vzener symbol appears, this voltage is being applied, and that all of the Vzener symbols are connected to each other by wires which for convenience's sake do not explicitly appear on the schematic. The power supply also contains a common terminal 24 of the circuit. It should be understood that all of the common terminals 24 are connected to each other by wires which for convenience's sake do not explicitly appear on the schematics.

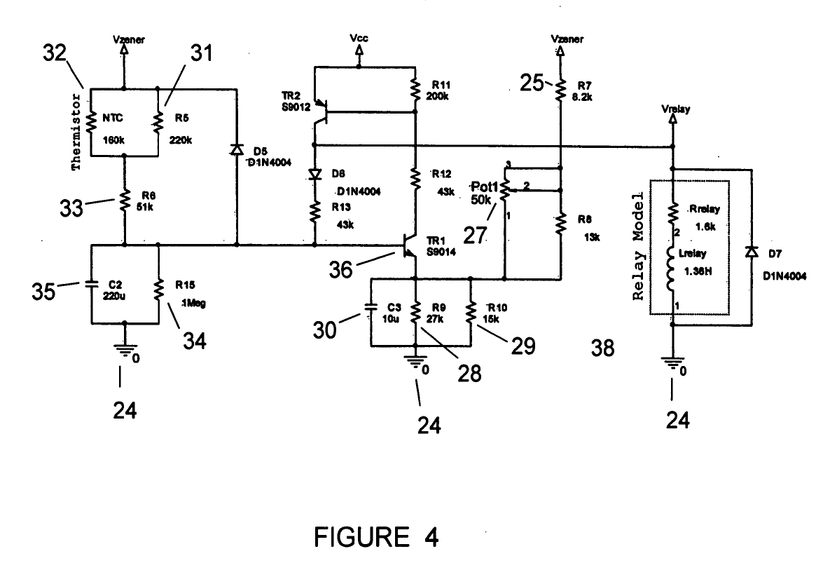

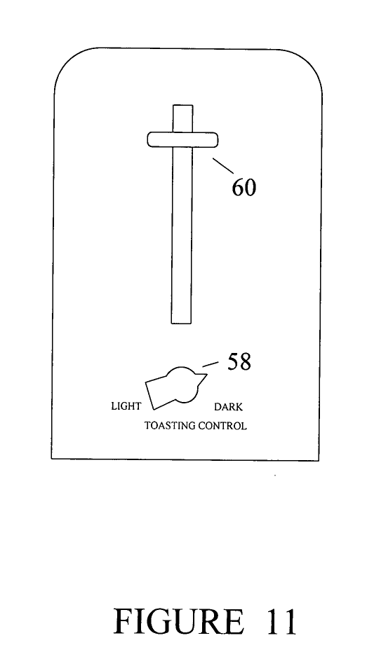

FIG. 4 is a schematic of the toast cycle timing circuit. As seen in FIG. 4, the regulated voltage, Vzener, is applied through a voltage divider consisting of a resistor 25, also labeled R7 on the schematic, in series with a resistor 26, also labeled R8 on the schematic, a potentiometer 27, also labeled Pot 1 on the schematic, and resistors 28 and 29, also labeled R9 and R10 on the schematic. Potentiometer 27 is the control on the toaster which sets the length of the toasting cycle, and it is physically connected to a toasting time control knob 58 which is shown in FIG. 11. The voltage divider charges a capacitor 30, also labeled C3 on the schematic, to a voltage level which depends on the setting of potentiometer 27. The voltage across capacitor 30 remains constant during the toasting cycle and serves as the threshold voltage for triggering the end of the toasting cycle.

The regulated voltage, Vzener, is also applied to a second voltage divider consisting of a resistor 31, also labeled R5 on the schematic, and a Thermistor 32 in series with a resistor 33, also labeled R6 on the schematic, and a resistor 34, also labeled R15 on the schematic. Because the resistances of resistor 31 and resistor 33 are much larger than the resistances of resistor 25 and resistor 26, and because the capacitance of a capacitor 35, also labeled C2 on the schematic, is much larger than the capacitance of capacitor 30; capacitor 35 charges very slowly. The time constant, τ, of the charging rate is given by the product of R, resistance, and C, capacitance, (i.e., τ=R×C).

Capacitor 35 slowly charges (i.e., the voltage across the capacitor slowly increases) until it reaches a level of about 0.5 volts above the reference voltage held on capacitor 30. At this point a transistor 36, also labeled TR1 on the schematic, begins to conduct (turns on) causing a transistor 37, also labeled TR2 on the schematic, to supply a voltage Vrelay to a relay 38, which ends the toasting cycle.

As will be further discussed below, the voltage Vrelay also powers a second timing circuit which controls the warming cycle and controls the indicator lights. It should be understood that all of the symbols Vrelay are connected to each other by wires which for convenience's sake do not explicitly appear on the schematics.

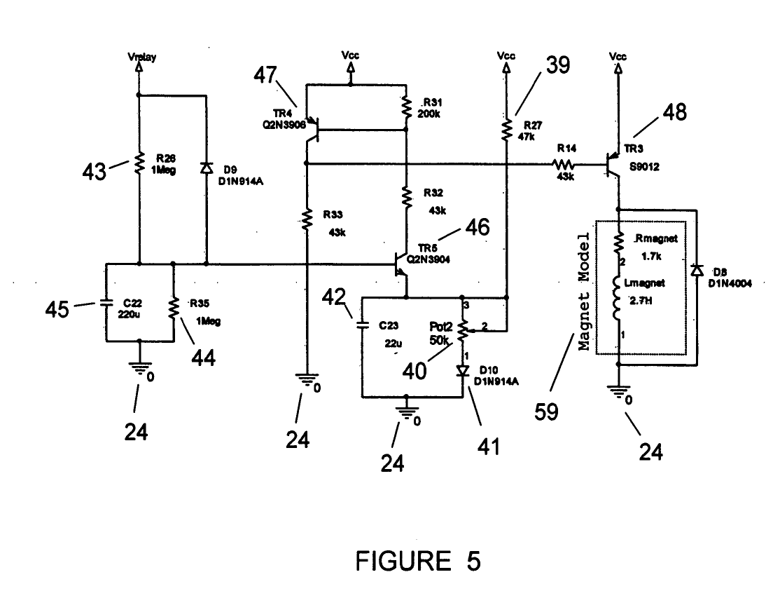

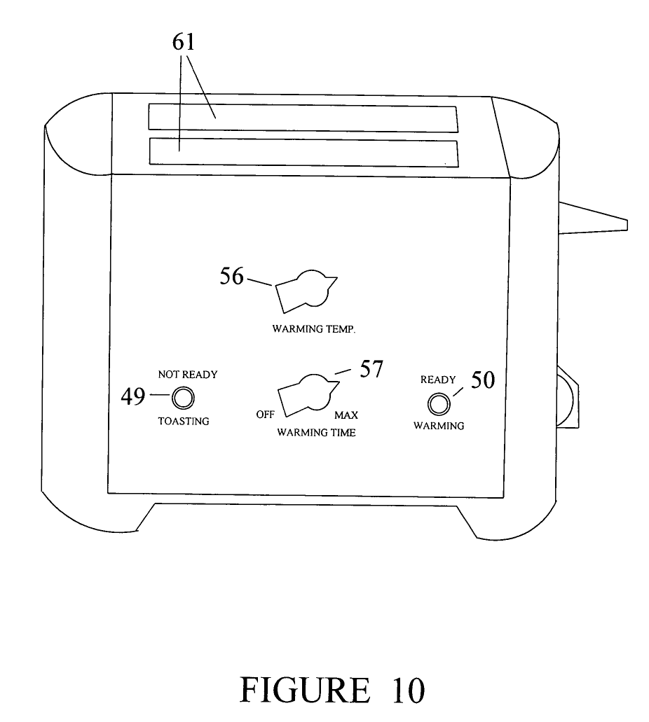

FIG. 5 is a schematic of the warming cycle timing circuit, which performs the timing of the warming function. As seen in FIG. 5, the voltage Vcc is applied through a third voltage divider consisting of a resistor 39, also labeled R27 on the schematic, in series with a potentiometer 40, also labeled Pot2 on the schematic, and a diode 41, also labeled D10 on the schematic. Potentiometer 40 is the control on the toaster which sets the length of the warming cycle, and it is physically connected to a warming time control knob 57 which is shown in FIG. 10. The voltage divider charges a capacitor 42, also labeled C23 on the schematic, to a voltage level which depends on the setting of potentiometer 40. The voltage across capacitor 42 remains constant during the toasting and warming cycles and serves as the threshold voltage for triggering the end of the warming cycle.

The relay voltage Vrelay (which was generated and applied to the relay to end the toasting cycle), is applied to a fourth voltage divider consisting of a resistor 43, also labeled R26 on the schematic, and a resistor 44, also labeled R35 on the schematic. Because the resistances of resistor 43 and resistor 44 are much larger than the resistances of resistor 39 and potentiometer 40, and because the capacitance of a capacitor 45, also labeled C22 on the schematic, is much larger than the capacitance of capacitor 42; capacitor 45 charges very slowly. The time constant, τ, of the charging rate is given by the product of R, resistance, and C, capacitance, (i.e., τ=R×C).

Capacitor 45 slowly charges (i.e., the voltage across the capacitor slowly increases) until it reaches a level of about 0.5 volts above the reference voltage held on capacitor 42. At this point a transistor 46, also labeled TR5 on the schematic, begins to conduct (turns on) causing a transistor 47, also labeled TR4 on the schematic, to turn off a transistor 48, also labeled TR3 on the schematic, which supplies the power to an electromagnet 59 that holds the basket down. This ends the heating cycle, releases the toast, and breaks the main power connection.

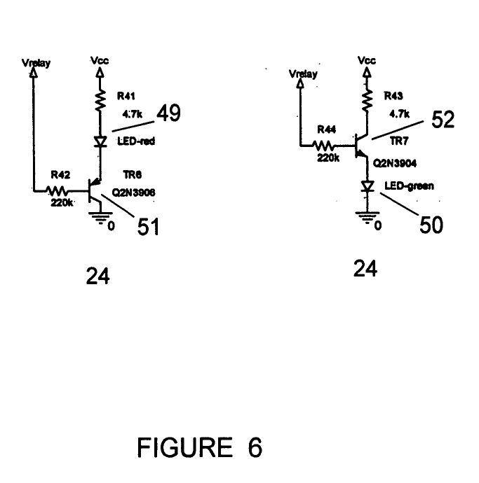

FIG. 6 is a schematic of the toasting and warming indicator lights. As seen in FIG. 6, indicators 49 and 50, also labeled LED-red and LED-green respectively on the schematic, are powered by the voltage Vrelay (which was generated and applied to relay 38 to end the toasting cycle). When the voltage Vrelay is low (approximately 0 volts while the toasting element is on during the toast cycle) a transistor 51, also labeled TR6 on the schematic, is turned on and current flows through indicator 49. Also while the voltage Vrelay is low, a transistor 52, also labeled TR7 on the schematic, is turned off preventing indicator 50 from lighting.

The end of the toasting cycle is marked by the voltage Vrelay becoming much larger (approximately 20 volts when the toasting element is being used as part of the warming system rather than toasting). When the voltage Vrelay increases, transistor 51 is turned off, extinguishing indicator 49. At the same time, the increasing voltage Vrelay turns on transistor 52 lighting indicator 50.

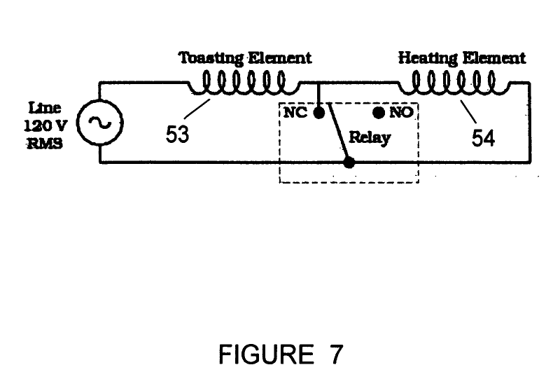

FIG. 7 is a diagram of the toasting and heating elements and the relay switch which enables the transition from higher-power toasting to lower-power warming. As seen in FIG. 7, when the toasting process begins, relay 38 is in the NC (normally closed) position and a toasting element 53 is connected directly across the power line and the power dissipated in toasting element 53 is P_{D} =V²/R_{T}, where V=120 V and R_{T} is the resistance of toasting element 53. When the toasting cycle is complete, relay 38 is activated and the relay contact moves to the NO (normally open) contact. Since the NO contact is not connected to anything, the circuit now consists of toasting element 53 and a heating element in series across the power line. In this case the power dissipated in both elements is P_{D}=V²/(R_{T}+R_{H}), where R_{H} is the resistance of heating element 54. Consequently, less power is used and the heat produced is much less, as required for warming rather than toasting.

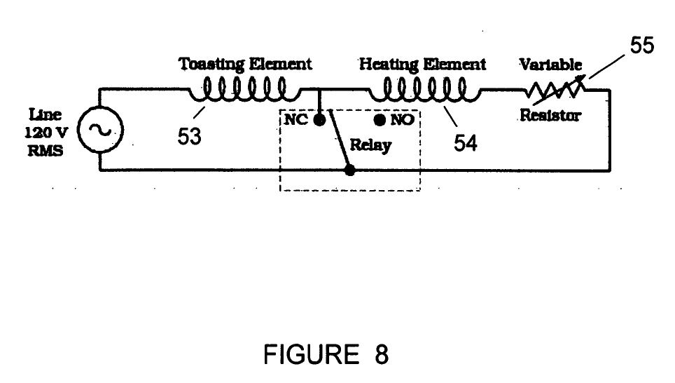

FIG. 8 is an alternative configuration of the toasting and heating elements, wherein a variable resistor 55 has been inserted into the circuit in series to control the power delivered to the toasting and heating elements, so that the user can vary the warming temperature. The total power dissipated by this system in the heating mode would be P_{D}=V²/(R_{T}+R_{H}+R_{V}), where R_{V} is the resistance of the variable resistor. Since variable resistor 55 will also be dissipating power, it should be sized such that its power rating of resistor is greater than P_{DR}=(R_{V}×V²)/(R_{T}+R_{H}+R_{V})², for all settings of R_{V}. Variable resistor 55 is physically connected in a suitable and conventionally known manner to a warming temperature control knob 56 which is shown in FIG. 10.

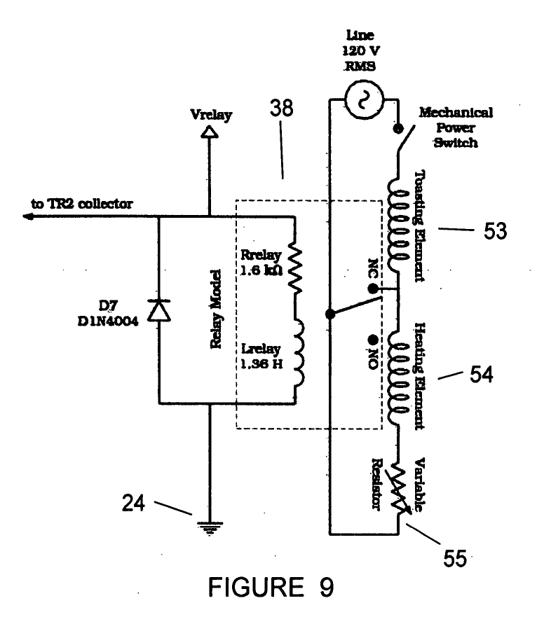

FIG. 9 illustrates the position of the toasting and heating elements in relation to the toast cycle timing circuit, or more specifically, their connection at relay 38. Relay 38 is part of the toasting cycle timing circuit which is also shown in FIG. 4, and relay 38 operates the switch which transitions the toaster from the toasting cycle to the warming cycle.

FIG. 10 is a perspective view of the toaster of the invention, showing toasting chambers 61, warming time control knob 57, warming temperature control knob 56, toasting indicator light 49, and warming indicator light 50. It should be understood that the user can set warming time control knob 57 to a “zero” or “off” setting, wherein no warming would take place and the toast would be ejected right after the toasting cycle as in a conventional toaster.

FIG. 11 is a side view of the toaster of the invention, showing the conventional lowering lever 60 that lowers the bread or other item into the toaster and the toasting time control knob 58.

It should be understood that for convenience's sake, not all of the conventional parts of a typical electronic magnetic hold down toaster are shown; for example, the spring-loaded baskets that hold the bread or other item to be toasted. These conventional parts are well known in the art, and are assumed to be employed in the invention. In addition, the actual physical appearance of some components—for example, the toasting element—are different than the simplistic appearance used for the schematics and diagrams.

While the above descriptions contain many specificities, these shall not be construed as limitations on the scope of the invention, but rather as exemplifications of embodiments thereof. Many other variations are possible without departing from the spirit of the invention. Examples of just a few of the possible variations follow:

The invention can be used to toast and then keep warm a variety of food items, including but not limited to bread, bagels, English muffins, and breakfast pastries. Therefore, when “bread” or “toast” is used for convenience in the foregoing description, it should be understood that the invention's use is not restricted to just bread or toast. Rather, it can be used with a wide variety of items.

The slots or openings at the top of the toaster can be differently-sized, to handle items having different shapes or sizes. The invention may have any number of toasting chambers, not just the two toasting chambers on the toaster shown in FIG. 10.

The toasting/warming circuitry can also be used with toaster ovens that do not eject the toast when done, but rather have a door that the user opens to insert the bread or remove the toast, or some other means of controlling the toasting cycle. In other words, the invention is not limited to pop-up toasters. Used in a toaster oven, for example, the circuitry of the invention would simply power off the heating elements upon completion of the warming cycle, rather than also powering off a magnet so that the toast could be ejected.

Accordingly, the scope of the invention should be determined not by the embodiments illustrated, but by the appended claims and their legal equivalents.

What is claimed is:

1. A toasting device, comprising:
(a) at least one toasting chamber;
(b) means for toasting an item in said at least one toasting chamber, said means comprising supplying power to a toasting element;
(c) means for keeping said item warm in said at least one toasting chamber after a toasting cycle is complete, said means comprising supplying power to said toasting element;
whereby said item is kept warm until ready for use.

2. The toasting device of claim 1, wherein said means for toasting further comprise a toasting cycle timing circuit that controls the operation of said toasting element.

3. The toasting device of claim 1, wherein said means for keeping warm further comprise a warming cycle timing circuit that controls the operation of said toasting element.

4. The toasting device of claim 1, wherein said means for keeping warm further comprise an additional heating element in series with said toasting element.

5. The toasting device of claim 1, wherein a warming time is predetermined by the user.

6. The toasting device of claim 5, wherein said warming time can be set at zero.

7. The toasting device of claim 1, wherein a warming temperature is predetermined by the user.

8. The toasting device of claim 1, wherein said toasting device also comprises means for indicating when said toasting cycle is in progress.

9. The toasting device of claim 1, wherein said toasting device also comprises means for indicating when a warming cycle is in progress.

10. The toasting device of claim 1, wherein said toasting device has a plurality of toasting chambers.

11. The toasting device of claim 1, wherein said toasting device is an electronically-controlled, magnetic hold-down toaster.

12. A method of keeping a toasted item warm, comprising the steps of:
(a) inserting an item into a toasting chamber of a toasting device;
(b) toasting said item in said toasting chamber by supplying power to a toasting element;
(c) keeping said item warm in said toasting chamber after said toasting step is complete by supplying power to said toasting element.

13. The method of claim 12, wherein said toasting step includes using a toasting cycle timing circuit to control the operation of said toasting element.

14. The method of claim 12, wherein said keeping warm step includes using a warming cycle timing circuit to control the operation of said toasting element.

15. The method of claim 12, wherein said keeping warm step includes using an additional heating element in series with said toasting element.

16. The method of claim 12, wherein said keeping warm step also includes predetermining a warming time.

17. The method of claim 16, wherein said warming time is predetermined to be zero.

18. The method of claim 12, wherein said keeping warm step also includes predetermining a warming temperature.

19. The method of claim 12, wherein said toasting step also includes providing means for indicating when said toasting step is in progress.

20. The method of claim 12, wherein said keeping warm step also includes providing means for indicating when said warming step is in progress.
